(19) United States
(12) Patent Application Publication
(10) Pub. No.: US 2013/0246276 A1
(43) Pub. Date: Sep. 19, 2013

(54) METHOD AND SYSTEM FOR MOBILE IDENTIFICATION, COMMERCE AND AGREEMENT TRANSACTIONS

(71) Applicant: Hee Chai Ooi, Nusajaya Johor (MY)

(72) Inventor: Hee Chai Ooi, Nusajaya Johor (MY)

(21) Appl. No.: 13/876,376

(22) PCT Filed: Sep. 30, 2011
(86) PCT No.: PCT/SG2011/000340

§ 371 Date: Jun. 6, 2013

(30) Foreign Application Priority Data
Sep. 30, 2010 (SG) 201007156-1

(51) Int. Cl. G06Q 20/32

(52) U.S. Cl. CPC G06Q 20/3255
USPC 705/44

(57) ABSTRACT

A method and system is described which uses the USSD (Unstructured Supplementary Services Data) protocol to allow users to conduct commerce and agreement transactions, and retrieve identification information in a secure manner.

### FIELD OF THE INVENTION

The present invention relates to a method and system that uses the USSD (Unstructured Supplementary Services Data) protocol for facilitating commerce and agreement transactions and retrieval of identification information.

### BACKGROUND

There exist today mobile payment schemes where a user can use mobile devices to make payment and transfer money using GPRS (General Packet Radio Service). However, this method can be rather costly when the user is registered to a foreign mobile network (mobile roaming) when overseas.

Using SMS (Short Message Service) protocol to initiate payment or transfer money on a mobile device is more economical than using GRPS. However, security measures and issues are compromised due to the nature of SMS being a ‘store and forward’ protocol, where messages sent or received can be retrieved by someone easily. Therefore, the SMS protocol may not be the most appropriate to input confidential data, as the confidential data will remain in the message, stored in the mobile device memory or SIM memory until the message is permanently deleted.

There also exists a need for a secure method that allows users to retrieve identification information and have it sent to their mobile device. There also exists a need for a secure method that allows users to upload, view and confirm agreements.

Therefore, the object of the invention is to provide a solution that overcomes the above disadvantages or at least provides a novel method and system for facilitating commerce and agreement transactions and retrieval of identification information.

### SUMMARY OF INVENTION

According to an embodiment a method is described for sending identification information from a server to a mobile device. The server has at least one application and the server is operatively connected to a database. The database stores the identification information of a plurality of users and each user has a universal identification number and a password. The method first involves the server establishing USSD communication with the mobile device and then pushing an application to the mobile device using USSD. The server then receives from the mobile device via USSD the password of a first user, an identification information request and the universal identification number of a selected user. The server then authenticates the password of the first user and the universal identification number of the selected user. The server then pushes the identification information of the selected user to the mobile device using a telecommunication protocol.

In another embodiment, the identification information is anyone of the following information: identity card, passport, membership, medical history, driving license and vehicle registration.

In another embodiment, the selected user is the first user or a second user.

In another embodiment, a method is described for using a server to send an offer. The server has at least one application and the server is operatively connected to a database. The database stores a plurality of users and each user has a universal identification number, a mobile device contact number, and a password. The method first involves the server receiving an upload of an agreement by a first user using a mobile device. The server then issues an agreement number to the first user. The server then establishes USSD communication with the mobile device and pushes an application to the mobile device using USSD. The server then receives from the mobile device via USSD the password of the first user, an offer request, the agreement number and the universal identification number of a second user. The server then authenticates the password of the first user, the agreement number and the universal identification number of the second user. The server then sends an offer to the mobile device contact number of the second user using a telecommunication protocol.

In another embodiment, a method is described for using a server to accept an offer. The server has at least one application and the server is operatively connected to a database. The database stores a plurality of users and each user has a universal identification number and a password. The method first involves the server displaying an agreement to a user, the user having a mobile device. The server then issues an acknowledgment number to the user after the user has read the agreement. The server then establishes USSD communication with the mobile device and pushes an application to the mobile device using USSD. The server then receives from the mobile device via USSD the password of the user, an acceptance request, the acknowledgment number and the universal identification number of the user. The server then authenticates the password of the user, the acknowledgment number and the universal identification number of the user. The server then sends an acceptance confirmation to the mobile device using a telecommunication protocol.

In another embodiment, a method is described for using a server to pay. The server has at least one application and the server is operatively connected to a database. The database has at least one holding account and stores a plurality of users. Each user has a universal identification number, an account, a mobile device contact number and at least one password. The method first involves the server establishing USSD communication with a first mobile device and pushing an application to the first mobile device using USSD. The server then receives from the first mobile device via USSD a payment request, the password of a first user, a payment amount and the universal identification number of a second user. The server then authenticates the password of the first user and the universal identification number of the second user. The server then debits the payment amount from the account of the first user and credits the payment amount to the holding account. The server then issues a transaction number and sends the transaction number to the first mobile device using a telecommunication protocol. The server then sends a message to the mobile device contact number of the second user. The server then establishes USSD communication with a second mobile device and pushes an application to the second mobile device using USSD. The server then receives from the second mobile device via USSD a payment confirmation, the password of the second user and the transaction number. The server then debits the payment amount from the holding account and credits the payment amount to the account of the second user.

In another embodiment, the password of the first user is an emergency use password.

In another embodiment, the method for using a server to pay further comprises the step of calling the first mobile device under the guise of a predetermined individual to verify the situation.

In another embodiment, the telecommunication protocol is anyone of the following: USSD, SMS, MMS and HTTP.

In another embodiment, a method is described for sending a message using a server. The server has at least one application and the server is operatively connected to a database. The database stores a plurality of users and each user has a universal identification number, a mobile device contact number and a password. The method first involves the server establishing USSD communication with a first mobile device and pushing an application to the first mobile device using USSD. The server then receives from the first mobile device via USSD the password of a first user, a send message request, a universal identification number of a second user and a series of text. The server then pushes via USSD the series of text in a message to a second mobile device based on the mobile device contact number of the second user, wherein the message is not stored in the second mobile device and will automatically disappear after an active session period.

The invention will now be described in detail with reference to the accompanying drawings.

### BRIEF DESCRIPTION OF THE DRAWINGS

In order that embodiments of the invention may be fully and more clearly understood by way of non-limitative examples, the following description is taken in conjunction with the accompanying drawings in which like reference numerals designate similar or corresponding elements, regions and portions, and in which:

FIG. 1 is a diagram illustrating a system in accordance with a preferred embodiment of the invention;

FIG. 2 is a flow chart illustrating a method for retrieving identification information in accordance with a preferred embodiment of the invention;

FIG. 3 is a flow chart illustrating a method for initiating an agreement transaction in accordance with a preferred embodiment of the invention;

FIG. 4 is a flow chart illustrating a method for agreeing with an agreement in accordance with a preferred embodiment of the invention;

FIG. 5 is a flow chart illustrating a method for disagreeing with an agreement in accordance with a preferred embodiment of the invention;

FIG. 6 is a flow chart illustrating a method for paying in accordance with a preferred embodiment of the invention;

FIG. 7 is a flow chart illustrating a method for paying to a holding account in accordance with a preferred embodiment of the invention;

FIG. 8 is a flow chart illustrating a method for collecting from a holding account in accordance with a preferred embodiment of the invention;

FIG. 9 is a flow chart illustrating a method for using VSMP in accordance with a preferred embodiment of the invention.

### DETAILED DESCRIPTION

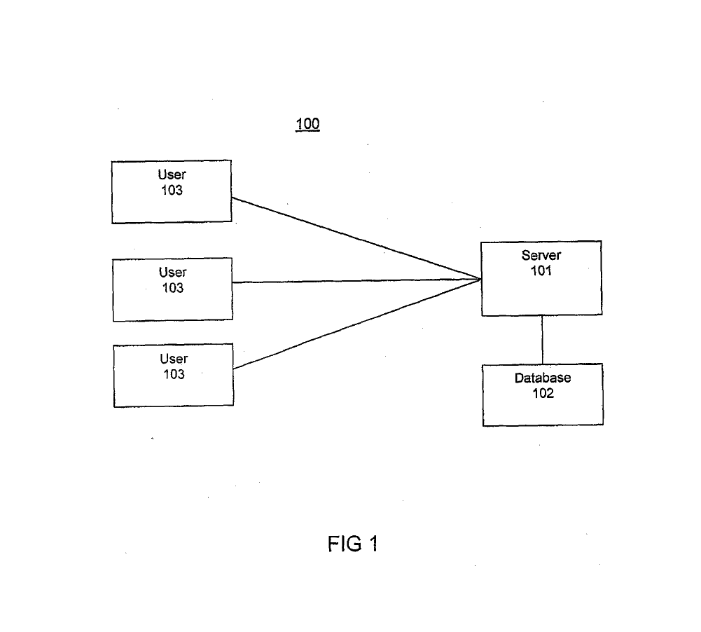

Referring to the drawings, FIG. 1 shows an exemplary system 100 for facilitating commerce and agreement transactions and retrieval of identification information using a mobile device. The system 100 comprises a server 101, a database 102, and registered users 103.

The server 101 contains applications. The server 101 can be connected to a database 102. Alternatively, the database 102 is within the server 101. A user 103 can be an individual user or a corporate user. After registration, the database 102 will contains entries of the users 103. The database 102 can also have holding accounts of various currencies.

The server 101 has built in functionality to push applications via USSD to mobile devices (includes mobile phones, tablets, laptops, notebooks and even desktops etc). USSD is a real time session oriented base protocol with no data storage capability, which makes it suitable for applications which involve secure and confidential information. Applications can be “pushed to” or “pulled by” a mobile device at no traffic cost and at a fast response rate. The applications that the server 101 provides to a user 103 include an “NRIC” application that allows users 103 to check their identification, “Offer” and “Agree” applications that allow users to provide and confirm agreements, a “Paydir” application that allow users 103 to pay one another. The various applications are described in further detail in the subsequent drawings. The server 101 also hosts a website which allows users access to it and its applications. Tie-ups with the respective local service providers allows this system to have an international reach.

Another functionality that the server 101 provides is VSMP (Very Secured Message Paging). VSMP is a proprietary secure messaging tool built upon the USSD protocol. VSMP is provided to users 103 as an application in the server 101. VSMP messages are pushed to a user's 103 mobile device. A user 103 can, within the active session period, respond to the VSMP message by clicking on the response button in the VSMP message. The VSMP message will automatically disappear from the screen of the user's mobile device (without any user intervention) after the end of the active session period. This is because VSMP messages are not stored in the mobile device but are simply being pushed to the mobile device during an USSD session. If the user 103 is unable to respond within the active session period, the user 103 can establish communication with the server 101 via USSD, login to the server 101 and then access the VSMP application, retrieve the VSMP message and respond at that time.

VSMP can thus prevent unauthorized viewing of its content as it has a password protection feature. The VSMP message is assigned to a particular user 103 with a unique universal identification number and therefore, only that particular user 103 with the valid universal identification number and password can view the VSMP message. VSMP messages can be accessed from any part of the world so long as there is a GSM network signal where USSD connections can be established with the server 101. GPRS and Wi-Fi connections are also not necessary for VSMP to work. And in the event that a user 103 loses his mobile phone, the VSMP messages are kept in the server 101 and therefore remain retrievable.

Furthermore, VSMP has integrated functionality with SMS such that it can also push SMS messages. However, in this case, the message is stored in the user's 103 mobile phone and can be viewed by anyone until the user 103 deletes the message from the user's 103 mobile phone. Alternatively, the server can also push a SMS message just as a notification to the user 103 to view a newly received VSMP message without actually displaying any confidential content. The user 103 can then login to the server 101 to access the VSMP message and view the confidential content.

An individual registers with the system 100 as a user 103 by disclosing personal particulars like GSM mobile number, GSM IMEI number etc. The server 101 then assigns the individual a Universal Identification Number. The individual's personal particulars and Universal Identification Number are then stored in an entry in the database 102. An individual can also upload his/her identification information into the database 102. This identification information can non-exhaustively include: identity card information, passport information, membership information, medical history, driving license and vehicle registration information. This identification information can be text based or can be a picture, for example a picture of the identity card or passport. The database 102 may also contain agreements or contracts which have been uploaded by an individual.

A small-size sticker can be issued to the individual that can be pasted on the back of a mobile phone or a small key chain. The small-size sticker can have information like the individual's Universal Identification Number and a Bar code number.

Accounts of any preferred or default currencies (for example, Singapore account, Malaysia account and United States account) are then setup for the individual and stored in the database 102. The server 101 assigns the individual a true-use password, and also preferably, an emergency-use password. Optionally, a verification password is also assigned to the individual. These passwords are changeable.

A true-use password is a conventional password for authentication purposes. The purpose of an emergency-use password is to act as a “warning” that something is amiss, for example if the individual is under duress and has been forced to transfer funds. For example, when the server 101 recognizes that an emergency-use password- has been used by an individual, the server 101 dispatches a caller to call the individual under the guise of a predetermined associate of the individual (for example, family member or friend) to speak to the individual to verify the situation. If the caller establishes that the individual is indeed under duress, the caller will contact the local authority to take action to help locate the individual.

A corporation registers with the system by disclosing corporate particulars, main and supplementary users (i.e. corporate users) and the GSM mobile numbers, GSM IMEI numbers of all corporate users. The server 101 then assigns each corporate user a Universal Identification Number. The corporate user's personal particulars and Universal Identification Numbers are then stored in an entry in the database 102. A corporate user can also upload his/her identification information into the database 102. This identification information can non-exhaustively include: identity card information, passport information, membership information, medical history, driving license and vehicle registration information. This identification information can be text based or can be a picture, for example a picture of the identity card or passport. The database 102 may also contain agreements or contracts which have been uploaded by a corporate user.

A small-size sticker can be issued to the corporate users that can be pasted on the back of a mobile phone or a small key chain. An even bigger sized sticker can also be issued and pasted at the business premises. An even bigger sized mobile display board can be showcased at the venue of the business. The stickers can have information like Universal Identification Number and Bar code number.

Accounts of any preferred or default currencies (for example, Singapore account, Malaysia account and United States account) are then setup for each corporate user and stored in the database 102. The server 101 assigns each corporate user a true-use password, and also preferably, an emergency-use password. Optionally, a verification password is also assigned to the individual. These passwords are changeable.

A true-use password is a conventional password for authentication purposes. The purpose of an emergency-use password is to act as a “warning” that something is amiss, for example if the corporate user is under duress and has been forced to transfer funds. For example, when the server 101 recognizes that an emergency-use password has been used by the corporate user, the server 101 dispatches a caller to call the corporate user under the guise of a predetermined associate of the corporate user (for example, family member or friend) to speak to the corporate user to verify the situation. If the caller establishes that the corporate user is indeed under duress, the caller will contact the local authority to take action to help locate the corporate user.

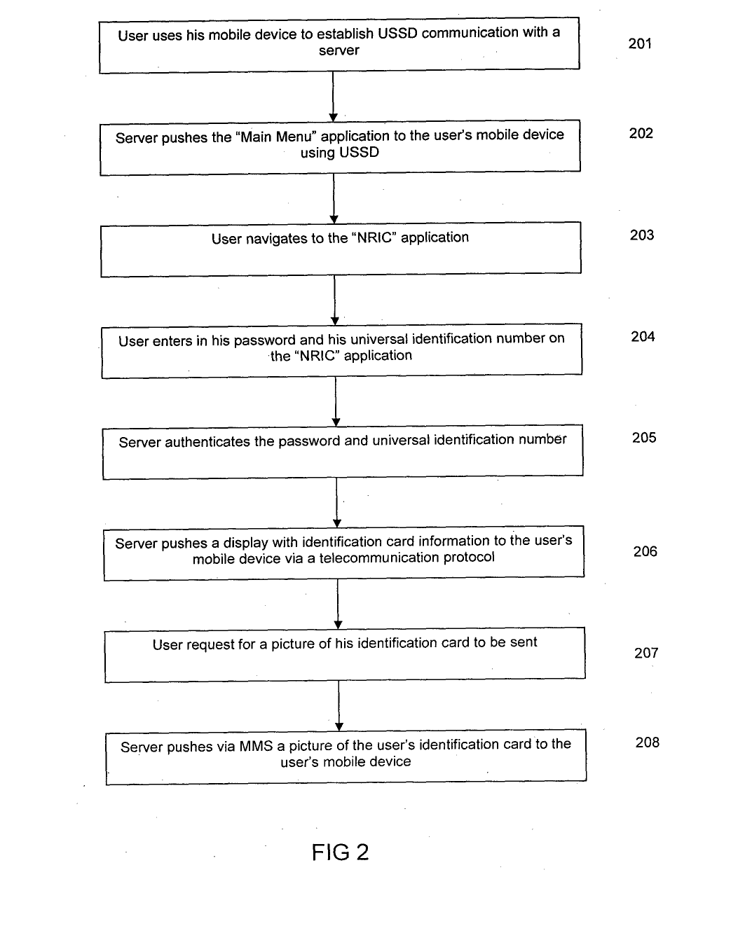

FIG. 2 shows a method in which a user can retrieve his identification information. In step 201, a user uses his mobile device to establish USSD communication with a server. This can be done by the user either calling a particular phone number or sending a short-code string via USSD. The server captures the user's mobile device details like mobile phone number and IMEI number.

In step 202, the server pushes the “Main Menu” application to the user's mobile device using USSD. The “Main Menu” application will appear as an interface on the user's mobile device. The interface will have sub-menus for the user to select from. The sub-menus can be “Cash”, “Bill”, “Identity”, “Agreement”, “Very-secured-msg-pager”, “promo-ads”, “Forex-rates”, “Password-MGT” and “Help”.

In step 203, the user navigates to the “NRIC” application by selecting on the “Identity” sub-menu and selecting the “NRIC” application.

In step 204, the user enters in his password and his universal identification number on the “NRIC” application and clicks OK, thereby sending this information to the server using USSD. The server processes this as an identification card information request.

In step 205, the server authenticates the password and universal identification number by checking them against the entries in the database to see if the password and universal identification number are valid.

In step 206, the server pushes a display that contains identification card information to the user's mobile device via a telecommunication protocol. The identification card information can include the following: universal identification number, identification card number, first and last name, nationality, race, sex, date of birth, date of issue. The telecommunication protocol can be one of the following: USSD, SMS, MMS (Multi-media Messaging Service) and HTTP (Hyper Text Transfer Protocol). The display also has an option for a user to select if the user wants to receive a picture of his identification card via MMS.

In step 207, the user requests for a picture of his identification card to be sent.

In step 208, the server pushes via MMS to the user's mobile device a picture of the user's identification card as well as a text reminder to delete the picture after verifying or viewing the picture.

In another embodiment, a user can use the “NRIC” application to retrieve the identification information of another user. In further embodiments, the user can instead of choosing the “NRIC” application, choose from the “Identity” sub-menu a “Passport” application or a “Membership” application or a “Medical history” application or a “Driving license” application or a “Vehicle registration” application if the user wants identification information pertaining to passport, memberships, medical history, driving license, or vehicle registrations.

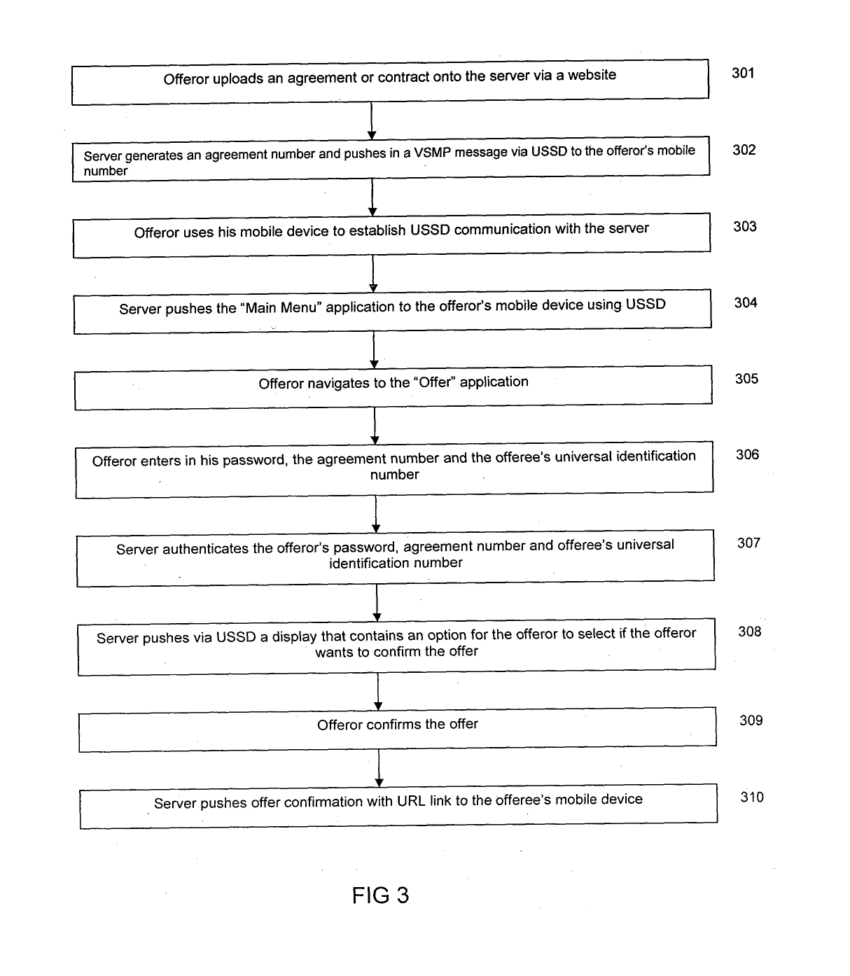

FIG. 3 shows an agreement transaction being initiated by an offeror for an offeree. Both offeror and offeree can be individual or corporate users. In step 301, an offeror uploads an agreement or contract onto the server via a website. The offeror does this by accessing the website using a browser, and inputting his true-use password and universal identification number. The offeror then navigates to the agreement upload URL (Universal Resource Locator), and then uploads the agreement by attaching the agreement (in PDF, word or other document formats) and clicking upload.

Once the uploading process is complete, in step 302, the server generates an agreement number and pushes it in a VSMP message to the offeror's mobile number via USSD, this mobile number being retrieved from the database as it is tagged to the offeror's universal identification number. Simultaneously, the agreement number will also be displayed on the offeror's browser. As the VSMP message will disappear from the screen of the offeror's mobile device after the end of the active session period, in the event that the offeror forgets the agreement number, the server provides an “Inbox” application and a “Outbox” application for the offeror to view past VSMP messages.

In step 303, the offeror uses his mobile device to establish USSD communication with the server. This can be done by the offeror either calling a particular phone number or sending a short-code string via USSD. The server captures the offeror's mobile device details like mobile device/phone number and IMEI number.

In step 304, the server pushes the “Main Menu” application to the offeror's mobile device using USSD. The “Main Menu” application will appear as an interface on the offeror's mobile device. The interface will have sub-menus for the offeror to select from. The sub-menus can be “Cash”, “Bill”, “Identity”, “Agreement”, “Very-secured-msg-pager”, “promo-ads”, “Forex-rates”, “Password-MGT” and “Help”.

In step 305, the offeror navigates to the “Offer” application by selecting on the “Agreement” sub-menu and selecting the “Offer” application.

In step 306, the offeror enters in his password, the agreement number and the offeree's universal identification number on the “Offer” application and clicks OK, thereby sending this information to the server using USSD. The server processes this as an offer request.

In step 307, the server authenticates the offeror's password, agreement number and offeree's universal identification number by checking them against the entries in the database to see they are valid.

In step 308, the server pushes via USSD a display that contains an option for the offeror to select if the offeror wants to confirm the offer.

In step 309, the offeror confirms the offer and this is sent to the server via USSD.

In step 310, the server retrieves the offeree's mobile number from the database and pushes the offer confirmation to the offeree's mobile device via a telecommunication protocol. The offer confirmation will show the offeror's universal identification number, the agreement number and the URL link where the agreement is uploaded on.

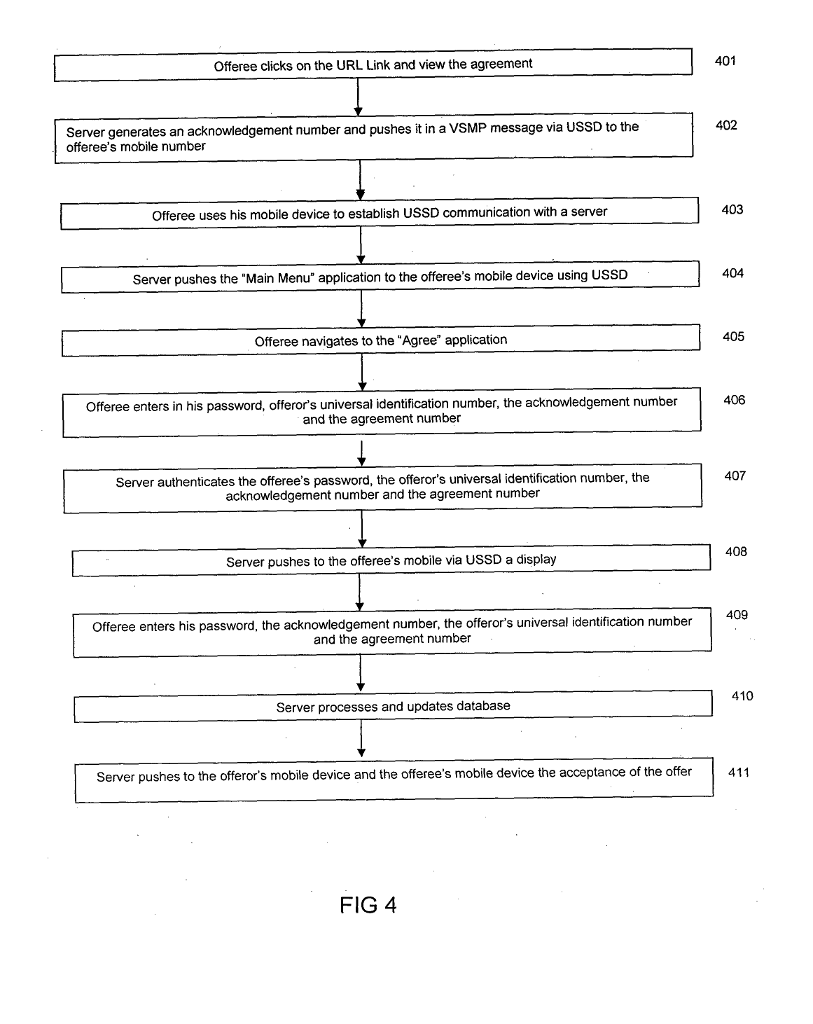

FIG. 4 shows an agreement transaction being accepted by the offeree in accordance with the invention. In step 401, the offeree clicks on the URL link, enters his true-use password and universal identification number and views the agreement on a browser. Alternatively, the offeree may also access the website using a browser, and login with his true-use password and universal identification number. The offeree then navigates to the agreement view URL.

After the offeree has read the agreement, the offeree must click a ‘Generate Acknowledgement Number’ button as an indication of acknowledgement. Clicking on the ‘Generate Acknowledgement Number’ button is not an indication of whether the offeree agrees or disagrees with the agreement. It simply indicates that the offeree has read the agreement.

After the offeree has clicked on the ‘Generate Acknowledgement Number’ button, in step 402, the server generates an acknowledgement number and pushes it in a VSMP message via USSD to the offeree's mobile number, this mobile number being retrieved from the database as it is tagged to the offeree's universal identification number. Simultaneously, the acknowledgement number will also be displayed on the offeree's browser. As the VSMP message will disappear from the screen of the offeree's mobile device after the end of the active session period, in the event that the offeree forgets the acknowledgement number, the server provides an “Inbox” application and a “Outbox” application for the offeree to view past VSMP messages.

In step 403, the offeree uses his mobile device to establish USSD communication with a server. This can be done by the offeree either calling a particular phone number or sending a short-code string via USSD. The server captures the offeree's mobile device details like mobile device/phone number and IMEI number.

In step 404, the server pushes the “Main Menu” application to the offeree's mobile device using USSD. The “Main Menu” application will appear as an interface on the offeree's mobile device. The interface will have sub-menus for the offeree to select from. The sub-menus can be “Cash”, “Bill”, “Identity”, “Agreement”, “Very-secured-msg-pager”, “promo-ads”, “Forex-rates”, “Password-MGT” and “Help”.

In step 405, the offeree navigates to the “Agree” application by selecting on the “Agreement” sub-menu and selecting the “Agree” application.

In step 406, the offeree enters in his password, the offeror's universal identification number, the acknowledgement number and the agreement number on the “agree” application and clicks OK, thereby sending this information to the server using USSD. The server processes this as an acceptance request.

In step 407, the server authenticates the offeree's password, the offeror's universal identification number, the acknowledgement number and the agreement number by checking them the entries in the database to see they are valid.

In step 408, the server pushes to the offeree's mobile device via USSD a display.

In step 409, the offeree enters in his password, the acknowledgement number, the offeror's universal identification number and the agreement number on the display and clicks OK, thereby sending this information to the server using USSD. The server processes this as a confirmation of acceptance.

In step 410, the server processes and updates database.

In step 411, the server pushes to the offeror's mobile device and the offeree's mobile device the acceptance of the offer.

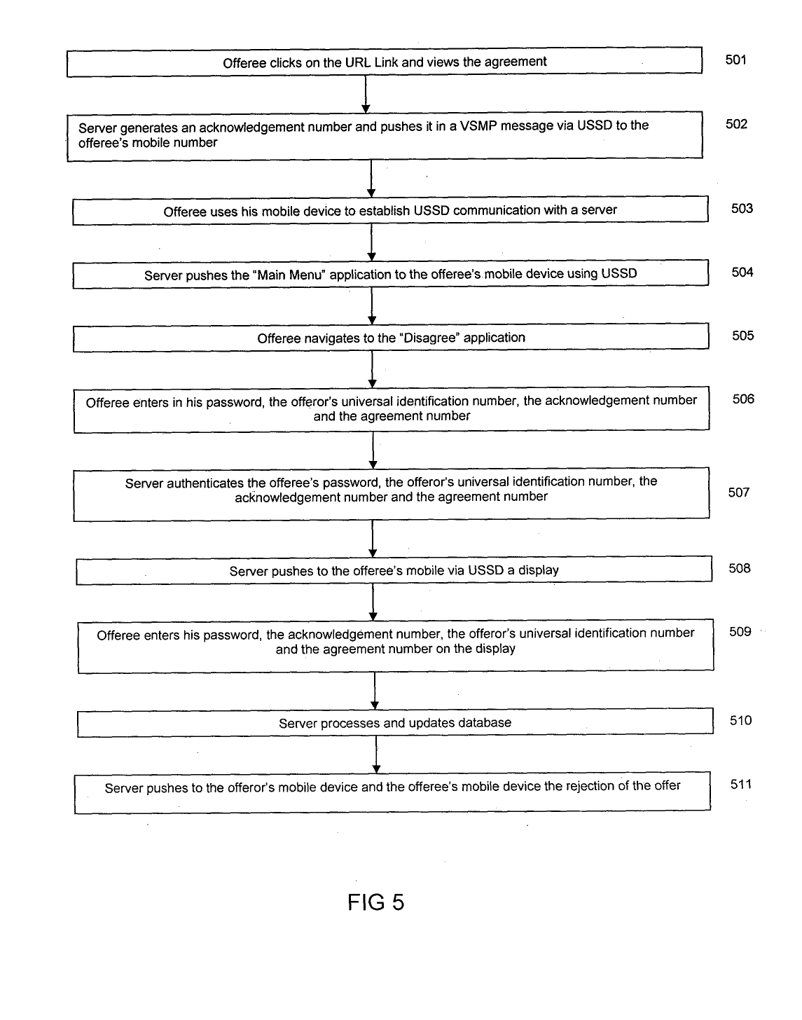

FIG. 5 shows a scenario where the agreement is not accepted by the offeree. Steps 501, 502, 503, 504 mirror the steps of 401, 402, 403 and 404 of FIG. 4.

In step 505, the offeree navigates to the “Disagree” application by selecting on the “Agreement” sub-menu and selecting the “Disagree” application.

In step 506, the offeree enters in his password, the offeror's universal identification number, the acknowledgement number and the agreement number on the “Disagree” application and clicks OK, thereby sending this information to the server using USSD. The server processes this as an agreement rejection.

In step 507, the server authenticates the offeree's password, the offeror's universal identification number, the acknowledgement number and the agreement number by checking them the entries in the database to see they are valid.

In step 508, the server pushes to the offeree's mobile device via USSD a display.

In step 509, the offeree enters in his password, the acknowledgement number, the offeror's universal identification number and the agreement number on the display and clicks OK, thereby sending this information to the server using USSD. The server processes this as a confirmation of rejection.

In step 510, the server processes and updates database.

In step 511, the server pushes to the offeror's mobile device and the offeree's mobile device the rejection of the offer.

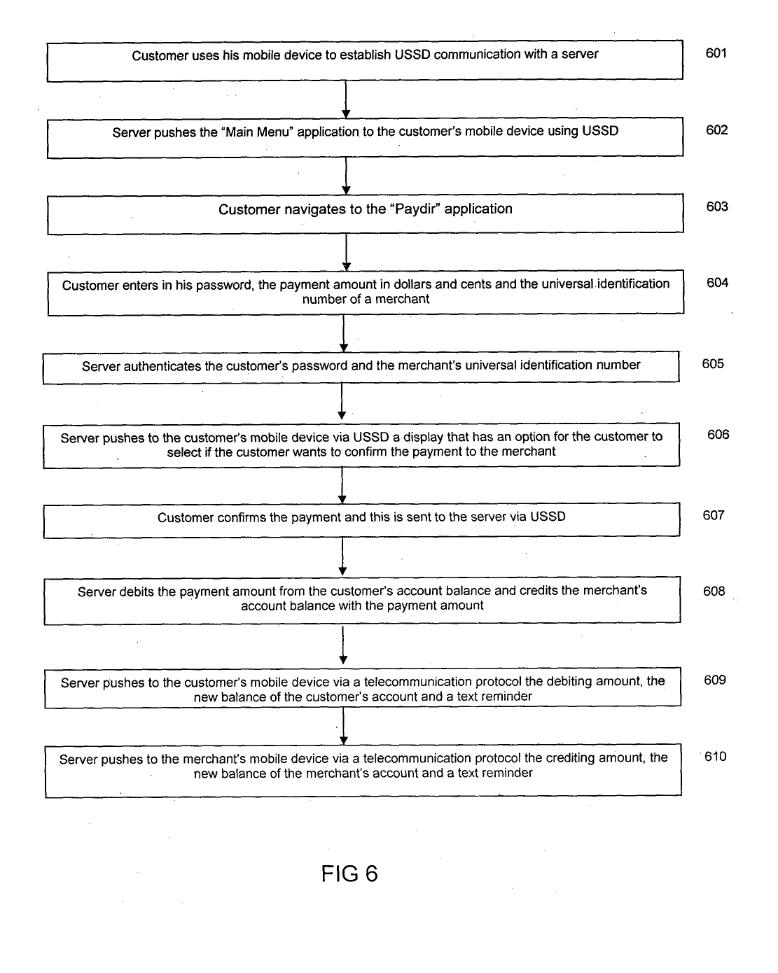

FIG. 6 shows a payment transaction between a customer (individual user) and a merchant (corporate user). In step 601, a customer uses his mobile device to establish USSD communication with a server. This can be done by the customer either calling a particular phone number or sending a short-code string via USSD. The server captures the customer's mobile device details like mobile device/phone number and IMEI number.

In step 602, the server pushes the “Main Menu” application to the customer's mobile device using USSD. The “Main Menu” application will appear as an interface on the customer's mobile device. The interface will have sub-menus for the user to select from. The sub-menus can be “Cash”, “Bill”, “Identity”, “Agreement”, “Very-secured-msg-pager”, “promo-ads”, “Forex-rates”, “Password-MGT” and “Help”.

In step 603, the customer navigates to the “Paydir” application (pay direct module) by selecting on the “Cash” sub-menu and selecting the “Paydir” application.

In step 604, the customer enters in his password, the payment amount in dollars and cents and the universal identification number of a merchant on the “Paydir” application and clicks OK, thereby sending this information to the server using USSD. The server processes this as a payment request.

In step 605, the server authenticates the customer's password and the merchant's universal identification number by checking them against the entries in the database to see if the password and universal identification number are valid. The server also checks to see if the payment amount (in the merchant's default currency) exceeds the customer's account balance.

In step 606, the server pushes to the customer's mobile device via USSD a display that has an option for the customer to select if the customer wants to confirm the payment to the merchant.

In step 607, the customer confirms the payment and this is sent to the server via USSD.

In step 608, the server debits the payment amount from the customer's account balance (in accordance with merchant's default currency) and credits the merchant's account balance with the payment amount.

In step 609, the server pushes to the customer's mobile device via a telecommunication protocol the debiting amount, the new balance of the customer's account and a text reminder to the customer to allow the merchant to verify the customer's universal identification number (which may be shown on a sticker attached to the mobile phone).

In step 610, the server pushes to the merchant's mobile device via a telecommunication protocol the crediting amount, the new balance of the merchant's account and a text reminder to the merchant to verify the customer's universal identification number. The merchant can skip this verification step if he is already certain who the customer who had just paid him is.

The server also has a “Rfund” application (refund module) which works in a reverse manner from the “Paydir” application where the merchant refunds the money back to the customer.

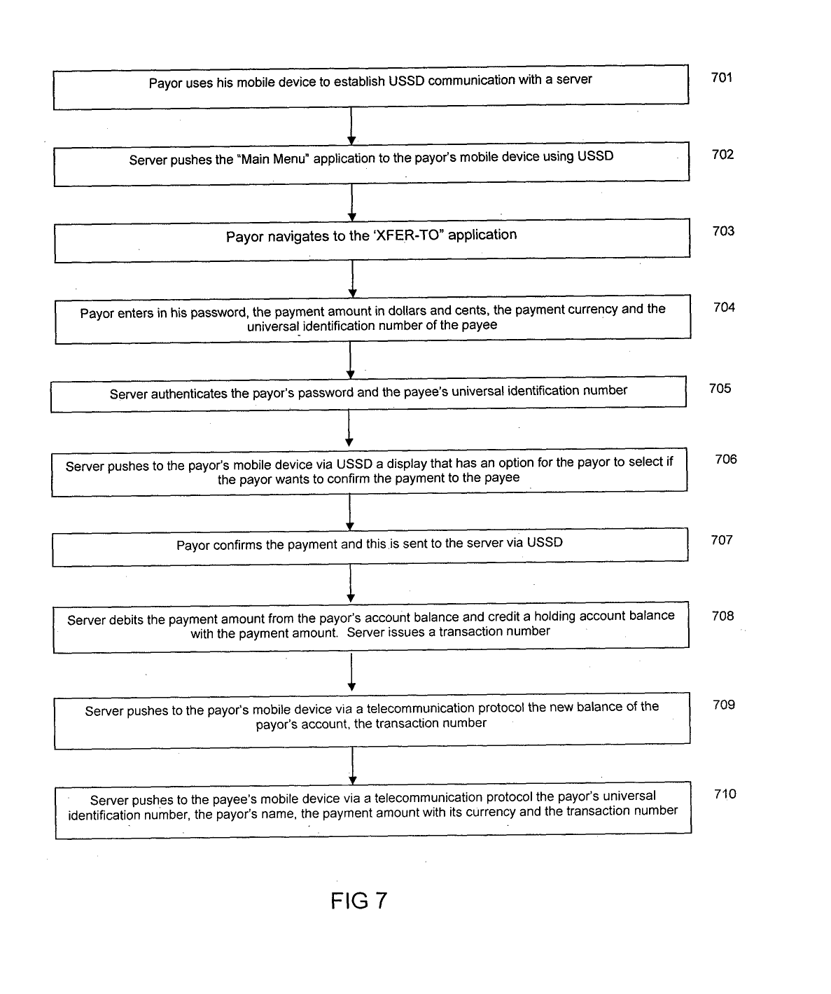

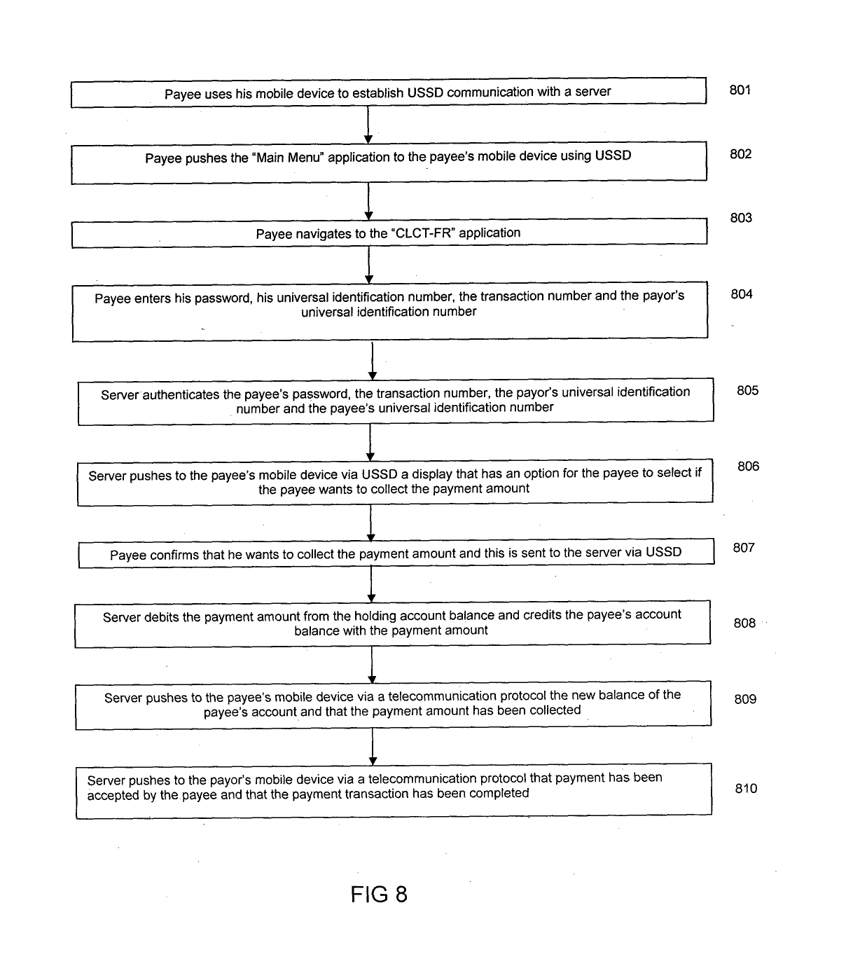

FIGS. 7 and 8 collectively show a payment transaction between two individual users, a payor and a payee. FIG. 7 shows the payment being transferred from a payor's account to a holding account. FIG. 8 shows the payment being transferred from a holding account to a payee's account.

In step 701, a payor uses his mobile device to establish USSD communication with a server. This can be done by the payor either calling a particular phone number or sending a short-code string via USSD. The server captures the payor's mobile device details like mobile device/phone number and IMEI number.

In step 702, the server pushes the “Main Menu” application to the payor's mobile device using USSD. The “Main Menu” application will appear as an interface on the payor's mobile device. The interface will have sub-menus for the user to select from. The sub-menus can be “Cash”, “Bill”, “Identity”, “Agreement”, “Very-secured-msg-pager”, “promo-ads”, “Forex-rates”, “Password-MGT” and “Help”.

In step 703, the payor navigates to the “XFER-TO” application (transfer to module) by selecting on the “Cash” sub-menu and selecting the “XFER-TO” application.

In step 704, the payor enters in his password, the payment amount in dollars and cents, the payment currency and the universal identification number of the payee on the “XFER-TO” application and clicks OK, thereby sending this information to the server using USSD. The server processes this as a payment request.

The payor can input the payment currency by keying in the corresponding 3-digit country code. For example, if the payor wants the payment currency to be in “USD”, he would key in 001 or if he wants the payment currency to be in “SGD”, he would key in 065. For countries that share a common country code, a special code can designed for them. A payor can only input a payment currency that he already has an account in. For example, if a payor only has an USD account and a SGD account, the payor can only choose USD or SGD as the payment currency.

In step 705, the server authenticates the payor's password and the payee's universal identification number by checking them against the entries in the database to see if the password and universal identification number are valid. The server also checks to see if the payment amount (in the selected payment currency) exceeds the payor's account balance.

In step 706, the server pushes to the payor's mobile device via USSD a display that has an option for the payor to select if the payor wants to confirm the payment to the payee.

In step 707, the payor confirms the payment and this is sent to the server via USSD.

In step 708, the server debits the payment amount from the payor's account balance and credit a holding account balance with the payment amount. The server issues a transaction number.

In step 709, the server pushes to the payor's mobile device via a telecommunication protocol the new balance of the payor's account, the transaction number.

In step 710, the server pushes to the payee's mobile device via a telecommunication protocol the payor's universal identification number, the payor's name, the payment amount with its currency and the transaction number, for the payee to execute the “CLCT-FR” application (collect from module).

In step 801, a payee uses his mobile device to establish USSD communication with a server. This can be done by the payee either calling a particular phone number or sending a short-code string via USSD. The server captures the payee's mobile device details like mobile device/phone number and IMEI number.

In step 802, the payee pushes the “Main Menu” application to the payee's mobile device using USSD. The “Main Menu” application will appear as an interface on the payee's mobile device. The interface will have sub-menus for the user to select from. The sub-menus can be “Cash”, “Bill”, “Identity”, “Agreement”, “Very-secured-msg-pager”, “promo-ads”, “Forex-rates”, “Password-MGT” and “Help”.

In step 803, the payee navigates to the “CLCT-FR” application by selecting on the “Cash” sub-menu and selecting the “CLCT-FR” application.

In step 804, the payee enters in his password, his universal identification number, the transaction number and the payor's universal identification number on the “CLCT-FR” application and clicks OK, thereby sending this information to the server using USSD. The server processes this as a collection of transferred amount request.

In step 805, the server authenticates the payee's password, the transaction number, the payor's universal identification number and the payee's universal identification number by checking them against the entries in the database to see if the password, universal identification numbers and transaction number are valid.

In step 806, the server pushes to the payee's mobile device via USSD a display that has an option for the payee to select if the payee wants to collect the payment amount.

In step 807, the payee confirms that he wants to collect the payment amount and this is sent to the server via USSD.

In step 808, the server debits the payment amount from the holding account balance and credits the payee's account balance with the payment amount.

In step 809, the server pushes to the payee's mobile device via a telecommunication protocol the new balance of the payee's account and that the payment amount has been collected.

In step 810, the server pushes to the payor's mobile device via a telecommunication protocol that payment has been accepted by the payee and that the payment transaction has been completed.

The “CLCT-FR” application acts as an extra check in the event that funds had been transferred to a wrong user. Moreover, as only a person with the correct universal identification number and password can collect the funds from the holding account, this method is very secure. Hence, even if a payee's loses his mobile device, the individual who picks up the payee's mobile device is unable to collect the funds from the holding account as he would not know the payee's password and/or correct universal identification number.

If the “CLCT-FR” application is not executed within a time period from the execution of the “XFER-TO” application, the payment amount will then be automatically credited back to the payor's account. For example, this time period can be 24 hours but can be set to any period of time by the server.

The server has a tandem of applications: “PPOO” application (Prepay on Order Module) and “CLOD” application (Claim on Delivery Module) which works similarly to the tandem of “XFER-TO” application and “CLCT-FR” application, except that in the “PPOO” application, the payment currency is the payor's default currency and the payment currency cannot be specified by the payor, and the transaction number is pushed only to the payor and not to the payee (unlike XFER-TO where the transaction number is pushed to both payor and payee). Therefore, the payor can withhold the transaction number and thus the payee's execution of the “CLOD” application to collect the funds until the payee hands him the goods.

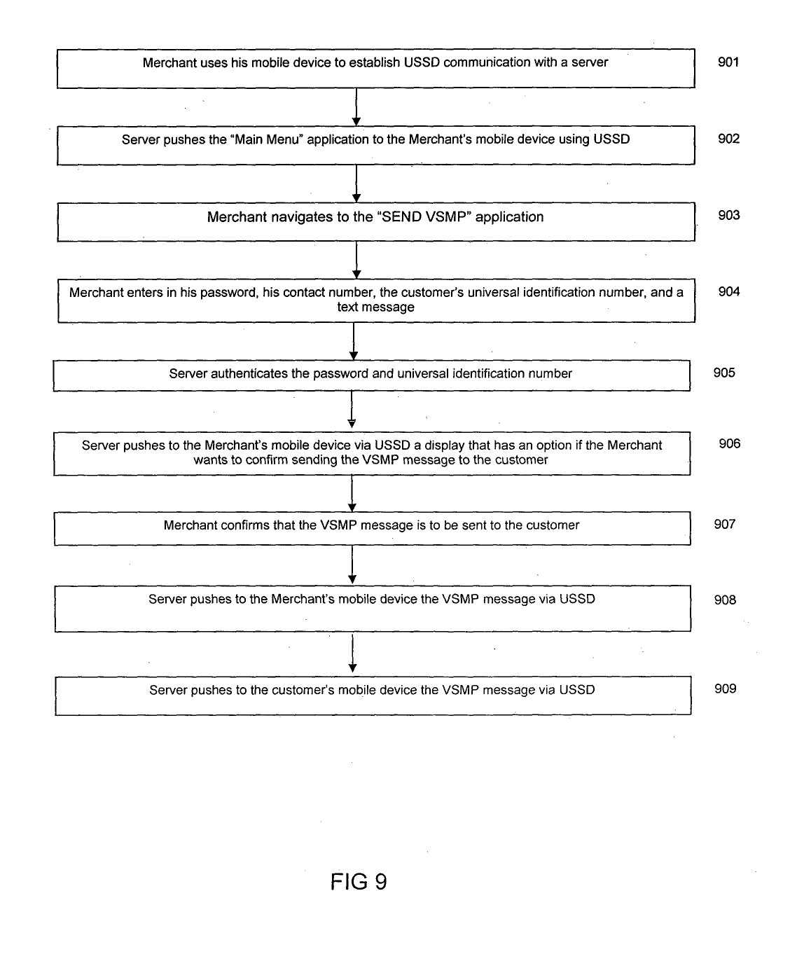

FIG. 9 shows a scenario where the VSMP is used. A Merchant (individual user) wants to beep a customer (individual user) to inform him that his food is ready and that he can come and collect it. In step 901, the merchant uses his mobile device to establish USSD communication with a server. This can be done by the merchant either calling a particular phone number or sending a short-code string via USSD. The server captures the merchant's mobile device details like mobile phone number and IMEI number.

In step 902, the server pushes the “Main Menu” application to the merchant's mobile device using USSD. The “Main Menu” application will appear as an interface on the merchant's mobile device. The interface will have sub-menus for the merchant to select from. The sub-menus can be “Cash”, “Bill”, “Identity”, “Agreement”, “Very-secured-msg-pager”, “promo-ads”, “Forex-rates”, “Password-MGT” and “Help”.

In step 903, the merchant navigates to the “SEND VSMP” application by selecting on the “Very-secured-msg-pager” sub-menu and selecting the “SEND VSMP” application.

In step 904, the merchant enters in his password, his contact number, the customer's universal identification number, and a text message on the “SEND VSMP” application and clicks OK, thereby sending this information to the server using USSD. The server processes this as a send VSMP message request. The text message will form the text in the VSMP message. The text message can either be keyed in by the merchant or chosen from prepared templates.

In step 905, the server authenticates the password and universal identification number by checking them against the entries in the database to see if the password and universal identification number are valid.

In step 906, the server pushes to the merchant's mobile device via USSD a display that has an option if the merchant wants to confirm sending the VSMP message to the customer.

In step 907, the merchant confirms that the VSMP message is to be sent to the customer.

In step 908, the server pushes to the merchant's mobile device the VSMP message via USSD.

In step 909, the server pushes to the customer's mobile device the VSMP message via USSD.

The “Very-secured-msg-pager” sub-menu also includes “Inbox” and “Outbox” applications which allows users to retrieve from the server VSMP messages received by and sent by the user.

VSMP can also be used in a self-collection scenario. A customer orders goods or services from a merchant. The customer pays using the “Paydir” application or some other mode (credit card, cash etc). If the customer uses the “Paydir” application, the merchant would have captured his universal identification number. Else, the merchant can choose to manually record the customer's universal identification number. Merchant can then either access the “SEND VSMP” application to send a VSMP message to the customer to collect the goods via the website or via USSD. In using the website, the merchant is not bound by a session timeout which is the case when using USSD. Also, the website allows a merchant to send VSMP messages to a plurality of customers at the same time. The merchant can also use a bar code scanner to scan the customer's universal identification number sticker at the back of the phone to avoid incorrectly inputting the customer's universal identification number.

VSMP can also be used to promote a “paperless” and environmental friendly environment. VSMP can be used to replace queue number tickets. A merchant can have a computer installed at the entrance of the shop with different bar code readers for different services. A customer simply needs to scan the bar code of the sticker pasted at the back of the phone to generate a queue number and initiate the queue waiting sequence. The merchant can then use send a VSMP message to the customer to notify the customer of his turn and the location of the counter that he must proceed to.

While exemplary embodiments pertaining to the invention have been described and illustrated, it will be understood by those skilled in the technology concerned that many variations or modifications involving particular design, implementation or construction are possible and may be made without deviating from the inventive concepts described herein.

1. A method for sending identification information from a server to a mobile device, the server having at least one application, and the server operatively connected to a database, the database storing the identification information of a plurality of users, each user having a universal identification number and a password;
the method comprising the steps of:
establishing USSD communication with the mobile device;
pushing an application to the mobile device using USSD;
receiving from the mobile device via USSD the password of a first user, an identification information request and the universal identification number of a second user;
authenticating the password of the first user and the universal identification number of the second user;
pushing the identification information of the second user to the mobile device using a telecommunication protocol; and wherein the identification information is anyone of the following information: identity card, passport, membership, medical history, driving license and vehicle registration.

2. (canceled)

3. (canceled)

4. A method for using a server to send an offer message, the server having at least one application, and the server operatively connected to a database, the database storing a plurality of users, each user having a universal identification number, a mobile device contact number, and a password;
the method comprising the steps of:
providing a universal resource locator for receiving an upload of an agreement by a first user using a first user mobile device, the agreement being a document and the universal resource locator having a link;
issuing an agreement number to the first user;
establishing USSD communication with the first user mobile device;
pushing an application to the first user mobile device using USSD;
receiving from the first user mobile device via USSD the password of the first user, an offer request, the agreement number and the universal identification number of a second user;
authenticating the password of the first user, the agreement number and the universal identification number of the second user;
sending an offer message to the mobile device contact number of the second user using a telecommunication protocol, wherein the offer message comprises the universal identification number of the first user, the agreement number and the link of the universal resource locator.

5. The method of claim 4 further comprising the steps of:
issuing an acknowledgment number to the second user after the second user has read the agreement, the second user having a second user mobile device;
establishing USSD communication with the second user mobile device;
pushing an application to the second user mobile device using USSD;
receiving from the second user mobile device via USSD the password of the second user, an acceptance request, the acknowledgment number, the agreement number and the universal identification number of the first user;
authenticating the password of the second user, the acknowledgment number, the agreement number and the universal identification number of the first user;
sending an acceptance confirmation to the first user mobile device and the second user mobile device using a telecommunication protocol.

6. A method for paying using a server, the server having at least one application, and the server operatively connected to a database, the database having at least one holding account and storing a plurality of users, each user having a universal identification number, an account, a mobile device contact number and at least one password;
the method comprising the steps of:
establishing USSD communication with a first mobile device;
pushing an application to the first mobile device using USSD;
receiving from the first mobile device via USSD a payment request, the password of a first user, wherein the password of the first user is an emergency use password, a payment amount and the universal identification number of a second user;
authenticating the password of the first user and the universal identification number of the second user;
debiting the payment amount from the account of the first user;
crediting the payment amount to the holding account;
issuing a transaction number and sending the transaction number to the first mobile device using a telecommunication protocol;
sending a message to the mobile device contact number of the second user;
establishing USSD communication with a second mobile device;
pushing an application to the second mobile device using USSD;
receiving from the second mobile device via USSD a payment confirmation, the password of the second user and the transaction number;
debiting the payment amount from the holding account;
crediting the payment amount to the account of the second user; and
calling the first mobile device under the guise of a predetermined individual to verify the situation.

7. (canceled)

8. (canceled)

9. The method of any claim 1 wherein the telecommunication protocol is anyone of the following: USSD, SMS, MMS and HTTP.

10. A method for sending a message using a server, the server having at least one application, and the server operatively connected to a database, the database storing a plurality of users, each user having a universal identification number, a mobile device contact number and a password;
the method comprising the steps of:
establishing USSD communication with a first mobile device;
pushing an application to the first mobile device using USSD;
receiving from the first mobile device via USSD the password of a first user, a send message request, a universal identification number of a second user and a series of text, wherein the series of text is keyed in by the first user;
authenticating the password of the first user and the universal identification number of the second user;
pushing via USSD the series of text in a message to a second mobile device based on the mobile device contact number of the second user; wherein the message is not stored in the second mobile device and will automatically disappear after an active session period.

11. The method of claim 1 wherein the telecommunication protocol is anyone of the following: USSD, SMS, MMS and HTTP.

12. The method of claim 4 wherein the telecommunication protocol is anyone of the following: USSD, SMS, MMS and HTTP.

13. The method of claim 5 wherein the telecommunication protocol is anyone of the following: USSD, SMS, MMS and HTTP.

14. The method of claim 6 wherein the telecommunication protocol is anyone of the following: USSD, SMS, MMS and HTTP.
